(19) United States
(12) Patent Application Publication
(10) Pub. No.: US 2007/0290657 A1
(43) Pub. Date: Dec. 20, 2007

(54) CIRCUIT AND METHOD FOR REGULATING VOLTAGE

(76) Inventors: David John Cretella, East Greenwich, RI (US); Denis Paul Galipeau, Woonsocket, RI (US); Daniel Krause, Kolbermoor (DE); Richard John Zinno, Cumberland, RI (US)

Correspondence Address: BRADLEY J. BOTSCH;SEMICONDUCTOR COMPONENTS INDUSTRIES, LLC, 5005 E. MCDOWELL ROAD, P.O.BOX 62890, INTELLECTUAL PROPERTY DEPT. - A700, PHOENIX, AZ, 85082, US

(21) Appl. No.: 11/424,222

(22) Filed: Jun. 14, 2006

(51) Int. Cl. G05F 1/00

(52) U.S. Cl. 323/222

(57) ABSTRACT

A hybrid regulator circuit and a method for regulating an output voltage. The hybrid regulator circuit includes a switching regulator, a linear regulator, a selector circuit, and an output capacitor which is shared by the switching regulator and the linear regulator. The selector circuit activates the linear regulator to provide a light load current. When the load current increases to a first predetermined level, the selector circuit activates the switching regulator and the linear regulator remains activated until the switching regulator ramps up to provide a sufficient amount of current so that the regulated output voltage does not droop or sag below a desired level. The selector circuit then deactivates the linear regulator. When the load current decreases to another predetermined level, the selector circuit reactivates the linear regulator and deactivates the switching regulator.

### FIELD OF THE INVENTION

This invention relates, in general, to electronic circuits and, more particularly, to voltage regulation in electronic circuits.

### BACKGROUND OF THE INVENTION

Voltage regulators are used in a variety of electronic products including automotive, aviation, telecommunications, consumer electronics, etc. Generally, voltage regulators provide a constant Direct Current (“DC”) voltage independent of the load current being drawn from the regulator or from any changes in the power supply feeding the voltage regulator. For example, in automotive applications the load current is different depending on whether the automobile is running or not. An automobile that is not running is said to be operating in a key-off or standby mode, and an automobile that is running is said to be operating in a key-on mode. The voltage regulator is preferably designed to provide a regulated output voltage for an automobile operating under heavy load conditions such as when it is operating in the key-on operating mode and for an automobile operating under light load conditions such as when it is operating in the key-off operating mode. In modern automobiles this task is complicated because of the number of systems included in the automobile. The systems may include, among others, fuel evaporative emission sampling systems, vacuum blower systems, keyless entry Radio Frequency (“RF”) receivers, keyless start/passive access (transponder) systems, and security systems. The systems are typically constructed from electronic modules that comprise the desired circuit functions or a subset of the desired circuit functions. To avoid the expense and weight of using a separate power supply for each module, they are typically designed to derive their power from a single power source such as an automobile's battery.

Modules that operate at low current levels use a linear regulator to provide a regulated voltage whereas modules that operate at high current levels use a switching or Pulse Width Modulated (“PWM”) regulator to provide a regulated voltage. Because of different current requirements during key-on and key-off operating modes, the operating currents of each module may span a range of currents that is sufficiently large that neither a linear nor a switching regulator is capable of providing a regulated voltage that meets the design specification for the modules. For example, a module may operate with a regulated voltage of 5 volts, have a peak operating current requirement of greater than 1 ampere, and a standby current requirement of 100 microamperes. During standby mode, a linear voltage regulator would be the best choice of regulator because it has a low operating current that discharges power sources, such as batteries in automobiles, slower than a switching regulator. However, during periods of high module activity, i.e., when there is a large load current, the current may exceed 1 ampere and the system voltage may be 16 volts or more. Under these conditions, a linear regulator dissipates such large power levels that a suitable thermal management technique would be difficult to implement in the module. A switching voltage regulator, on the other hand, can have greater than 80 percent efficiency during periods of high module activity under identical load/input conditions. Therefore, it can operate with reduced power dissipation. However, a drawback with the switching regulator is that during the standby operating mode, its quiescent current consumption is larger than that of a linear regulator, and therefore it discharges power sources such as batteries more rapidly than a linear regulator.

Hence, a need exists for an electronic circuit such as a voltage regulator and a method of providing voltage regulation with high efficiency during high module activity and consuming low quiescent current during low module activity. In addition, it is desirable for the electronic circuits to be cost and time efficient to manufacture.

### BRIEF DESCRIPTION OF THE DRAWINGS

The present invention will be better understood from a reading of the following detailed description, taken in conjunction with the accompanying drawing figures, in which like reference characters designate like elements, and in which:

FIG. 1 is schematic diagram of a regulator network comprising a selector circuit, a linear regulator, and a switching regulator in accordance with an embodiment of the present invention;

FIG. 2 is a schematic diagram of a portion of the switching regulator of FIG. 1 in accordance with another embodiment of the present invention;

FIG. 3 is a schematic diagram of the selector circuit of FIG. 1 in accordance with an embodiment of the present invention; and

FIG. 4 is a timing diagram of the operation of the regulator network of FIG. 1.

### DETAILED DESCRIPTION

In general, the present invention includes a method and circuit for regulating an output voltage of an electronic circuit. The present invention includes a hybrid voltage regulator comprising a linear regulator, a switching regulator, and a selector circuit for choosing whether the linear regulator, the switching regulator, or both are active. In accordance with one embodiment of the present invention, the linear regulator regulates the output voltage when the hybrid voltage regulator provides power for a small load current, e.g. a load current of less than approximately 2 milliamps (mA). When the load current rapidly increases to a level greater than or equal to a predetermined level, e.g. approximately 20 mA, the selector circuit enables or switches on the switching regulator. Because of the rapid increase in load current, the output voltage V_{OUT} may droop to a level that can cause erroneous signal processing such as, for example, resetting a microprocessor. Thus, the linear regulator remains enabled to provide additional load current. Once the switching regulator has provided sufficient current to reestablish output voltage regulation to within some tolerance of its nominal value, e.g., a tolerance ranging from approximately 1% to approximately 5% of the nominal output voltage, the linear regulator is disabled or deactivated. The nominal value is a predetermined output voltage level. An advantage of the present invention is that the linear regulator provides current while the switching regulator ramps up to its nominal output current, thereby preventing the output voltage V_{OUT} from dropping to a level that might cause erroneous signal processing.

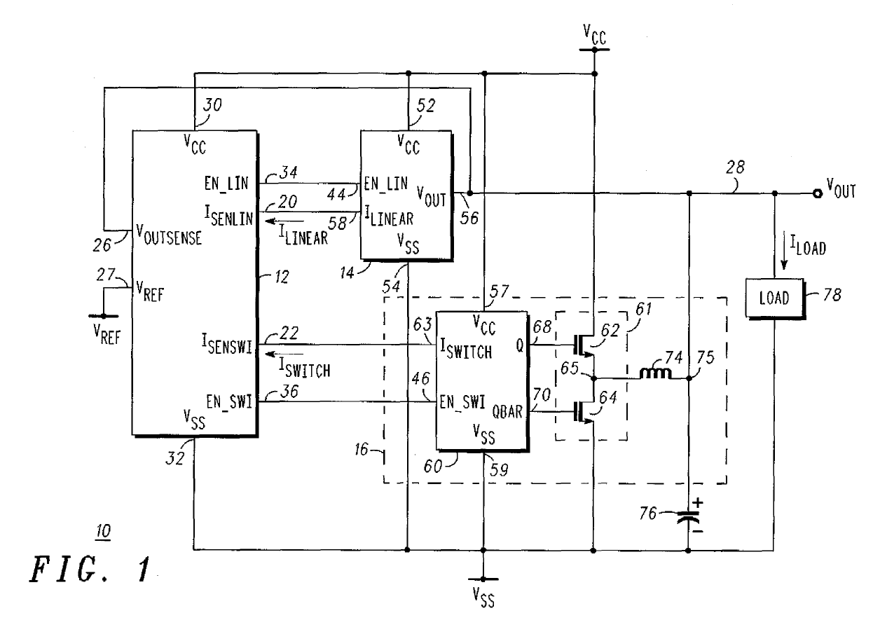

FIG. 1 is a block diagram of a hybrid voltage regulator 10 in accordance with an embodiment of the present invention. Hybrid voltage regulator 10 comprises a selector circuit 12 connected to a linear regulator 14 and to a switching regulator 16, which share an output capacitor 76, i.e., linear regulator 14 and switching regulator 16 are connected to output capacitor 76. Selector circuit 12 has current sense inputs 20 and 22 for receiving sensing signals I_{SENLIN} and I_{SENSWI}, respectively. Sensing signals I_{SENLIN} and I_{SENSWI} provide a means for monitoring a load current I_{LOAD}. It should be noted that voltage sense input 26 serves to sense whether output voltage V_{OUT} is within a tolerance of its desired level and is therefore labeled V_{OUTSENSE} in selector circuit 12. It should be further noted that reference voltage input 27 is coupled for receiving a reference voltage V_{REF} and is therefore labeled V_{REF} in selector circuit 12. Selector circuit 12 further includes an input 30 coupled for receiving a source of operating potential such as, for example, V_{CC}, and an input 32 coupled for receiving a source of operating potential such as, for example, V_{SS}. By way of example, in a battery operated application, V_{CC} is coupled for receiving a voltage from a battery and V_{SS} is coupled for receiving a potential substantially equal to ground. Selector circuit 12 has enable outputs 34 and 36 which provide enable signals EN_LIN and EN_SWI to enable input 44 of linear regulator 14 and enable input 46 of switching regulator 16, respectively. Selector circuit 12 is further described with reference to FIG. 3. Each regulator 14 and 16 has current sense sections for sensing load current I_{LOAD}.

Linear regulator 14 has an input 52 coupled for receiving a source of operating potential such as, for example, V_{CC}, an input 54 coupled for receiving a source of operating potential such as, for example, V_{SS}, and an output 56 connected to output node 28 and to output capacitor 76. Linear regulator 14 and switching regulator 16 share output capacitor 76. Linear regulator 14 has a current sense section (not shown) coupled to an output 58 for transmitting a current sense signal I_{LINEAR}. Output 58 is connected to input 20 of selector circuit 12 and serves as a sensing output. Linear regulator 14 further includes an input 44 coupled to output 34 of selector circuit 12 for receiving an enable signal EN_LIN.

Switching regulator 16 comprises a controller 60, a switching circuit 61, an inductor 74, a current sense section for sensing load current I_{LOAD}, and an output 75 connected to output node 28 and to output capacitor 76. It should be understood that typically inductor 74 is a discrete element coupled to switching circuit 61. However, this is not a limitation of the present invention and controller 60, switching circuit 61, and inductor 74 may be integrated on a single semiconductor substrate. Controller 60 has an input 57 coupled for receiving a source of operating potential such as, for example, V_{CC}, an input 59 coupled for receiving a source of operating potential such as, for example, V_{SS}, and outputs 68 and 70 connected to switching circuit 61. Control outputs 68 and 70 are labeled Q and QBAR, respectively, within controller 60. Controller 60 has an input 46 connected to output 36 of selector circuit 12 for receiving an enable signal EN_SWI and a current sense section (not shown) coupled to an output 63 for transmitting a current sense signal I_{SWITCH} to selector circuit 12. Output 63 is connected to input 22 of selector circuit 12 and serves as a sensing output.

In accordance with one embodiment, switching circuit 61 comprises a pair of switching field effect transistors (“FETs”) 62 and 64, wherein each FET has a gate, a source, and a drain. Control output 68 of controller 60 is connected to the gate of switching transistor 62 and complementary control output 70 of controller 60 is connected to the gate of switching transistor 64. The source of switching transistor 64 is coupled for receiving a source of operating potential such as, for example, V_{SS}, and the drain of switching transistor 64 is connected to the source of switching transistor 62 at node 65. The drain of switching transistor 62 is coupled for receiving a source of operating potential such as, for example, V_{CC}. It should be understood that the circuit implementation of switching circuit 61 is not a limitation of the present invention. For example, switching circuit 61 may be comprised of a P-channel FET and a diode in place of FETs 62 and 64, respectively. Briefly referring to FIG. 2, the embodiment of switching circuit 61 comprising a P-channel FET 67 and a diode 69 is shown. Alternatively, switching circuit 61 can be comprised of N-channel FET 64 and a P-channel FET in place of N-channel FET 62, or bipolar junction transistors (rather than FETs), diodes, or combinations thereof with appropriate changes in controlling signals such that current flow at any given time is essentially through one of the devices in switching circuit 61.

Referring again to FIG. 1, one terminal of an inductor 74 is connected to node 65 and the other terminal of inductor 74 is connected to output terminal 56 of linear regulator 14 and to one terminal of capacitor 76 at node 75. The connection of output 75 to output 56 and capacitor 76 forms an output node 28. The other terminal of output capacitor 76 is coupled for receiving a source of operating potential such as, for example, V_{SS}.

A load 78 is coupled between output node 28 and a source of operating potential such as, for example, V_{SS} and carries a current I_{LOAD}. Load 78 is in parallel with output capacitor 76.

FIG. 3 illustrates a block diagram of selector circuit 12 in accordance with an embodiment of the present invention. What is shown in FIG. 3 is a voltage comparator 80 having inverting input 26 coupled for receiving output voltage signal V_{OUT} (shown in FIG. 1), non-inverting input 27 coupled for receiving reference signal V_{REF}, and an output that is connected to an input 83 of a control logic circuit 84. Input 83 receives a control signal ASSIST from voltage comparator 80. Control logic circuit 84 has an input 86 that receives an activation or enable signal PWMEN from an upshift comparator 102 and an input 88 that receives an activation or enable signal LINEN from a downshift comparator 104. In response to the activation signals from upshift comparator 102 and downshift comparator 104, control logic circuit 84 generates a pulse width modulator enable signal EN_SWI at output 36 and a linear regulator enable signal EN_LIN at output 34.

Upshift comparator 102 cooperates with downshift comparator 104 and a transition current reference generator 106 to form a comparator network 100, which is a portion of selector circuit 12. Upshift comparator 102 has a non-inverting input that serves as current sense input 20 and an inverting input 103 coupled to current reference generator 106. Downshift comparator 104 has an inverting input that serves as current sense input 22 and a non-inverting input 107 connected to current reference generator 106. Upshift comparator 102 and downshift comparator 104 control whether linear regulator 14 or switching regulator 16 is enabled. Current reference 106 provides a reference signal I_{REF1}, to inverting input 103 of upshift comparator 102 and a reference signal I_{REF2} to non-inverting input 107 of downshift comparator 104. Reference current signal I_{REF1} is greater than reference current signal I_{REF2}. When current sense signal I_{LINEAR} is greater than reference current signal I_{REF1}, switching or PWM regulator 16 is enabled and linear regulator 14 is disabled. When current sense signal I_{SWITCH} is less than reference current signal I_{REF2}, linear regulator 14 is enabled and switching regulator 16 is disabled. In accordance with this embodiment, the comparison is made based on currents such as, for example, sense currents I_{LINEAR} and I_{SWITCH} being greater than or less than a predetermined reference value. It should be understood that the comparison is not limited to being the comparison of currents but can be that of other types of signals.

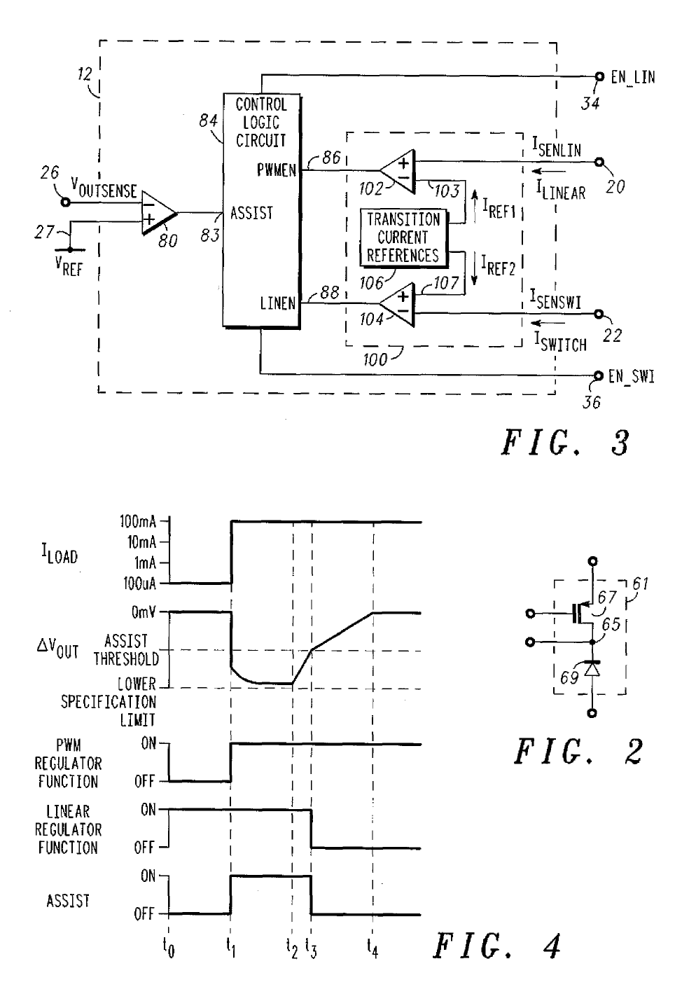

In a system such as, for example, an automobile, operation typically begins in a key-off operating mode. In this operating mode, the load current I_{LOAD} drawn from the battery is low or light, i.e., less than approximately 2 mA and typically less than approximately 100 microamps (μA). Load current I_{LOAD} is low because any sub-systems receiving power from the battery are operating in low current standby mode. Examples of these sub-systems include modules such as keyless entry RF receivers, keyless start/passive access (transponder) systems, security systems, and the like. It should be noted that the systems listed are merely exemplary systems and the list is not a limitation of the present invention. For the sake of explanation, in the key-off operating mode, linear regulator 14 is assumed to be on or activated and switching regulator 16 is assumed to be off or deactivated. The current sense section of linear regulator 14 provides a current sense signal I_{LINEAR} to input 20 of selector circuit 12 that is less than reference current signal I_{REF1}. In this operating mode, switching regulator 16 is disabled or deactivated, provides substantially zero current to the load, and current sense signal I_{SWITCH} is less than reference current signal I_{REF2}. It should be understood that while switching regulator 16 is disabled or deactivated a leakage current may flow, but the leakage current is much smaller than the current that flows when switching regulator 16 is activated. For this description the leakage current can be considered to be zero. In response to current signal I_{LINEAR} being less than reference current signal I_{REF1}, comparator 102 causes control logic circuit 84 to generate an enable signal at output 34 which enables linear regulator 14 and a disable signal at output 36 which disables switching regulator 16. The output responses for this configuration are illustrated between times t₀ and t₁ of FIG. 4. In this operating mode, the system is in equilibrium, a load current I_{LOAD} of approximately 100 μA is provided by linear regulator 14, and output voltage V_{OUT} is regulated at its nominal value. Thus the change in output voltage (ΔV_{OUT}) is substantially 0 millivolts.

Linear regulator 14 remains enabled and switching regulator 16 remains disabled until the system, e.g., the automobile, enters a key-on operating mode. In the key-on operating mode, load current I_{LOAD} increases to a high enough level that the current sense section of linear regulator 14 provides a current sense signal I_{LINEAR} to input 20 of selector circuit 12 that is greater than reference current signal I_{REF1}. In response to current sense signal I_{LINEAR} being greater than current reference signal I_{REF1}, the output signal of comparator 102 changes state. This output signal appears at input 86 of control logic circuit 84 causing it to generate enable signal EN_SWI, which is transmitted from output 36 to switching regulator 16, thereby, enabling switching regulator 16.

The increase in load current I_{LOAD} in cooperation with the effective series resistance of output capacitor 76 generates a negative voltage pulse that is transmitted to voltage sense input 26 of selector circuit 12. The negative voltage pulse causes output voltage V_{OUT} that appears at input 26 to become lower than reference voltage V_{REF}. Comparator 80 generates an assist signal ASSIST which prevents enable signal EN_LIN from going low. Assist signal ASSIST is also referred to as a linear control signal or a linear assist signal. Linear regulator 14 remains on while switching regulator 16 powers up, keeping output voltage V_{OUT} from drooping by more than a lower specification limit as shown between times t₁ and t₄ in FIG. 4. For example, at time t₁ load current I_{LOAD} steps up from 100 μA to 100 mA. Since switching regulator 16 needs a finite time to respond, the initial current to the load is provided by discharging output capacitor 76. The current flowing out of output capacitor 76 causes a voltage drop in output voltage V_{OUT} such that it falls below the ASSIST threshold level. Voltage sense circuitry in selector circuit 12 senses voltage V_{OUT} at input 26 and detects a need for additional current to increase output voltage V_{OUT} to its nominal or desired level. In response, comparator 80 asserts a linear assist signal ASSIST and places linear regulator 14 in an assist operating mode, i.e., linear regulator 14 assists switching regulator 16 by continuing to supply current until the current provided by linear regulator 14 and switching regulator 16 reaches a level sufficient to return output voltage V_{OUT} to within some predetermined tolerance of a nominal level. Control signal ASSIST maintains linear regulator 14 in an active mode independent of sense signal I_{LINEAR}. Linear regulator 14 increases its output current in an effort to bring output voltage V_{OUT} back into regulation. In addition, the increased load current activates or enables switching regulator 16, which supplies current through inductor 74 to load 78. The current from linear regulator 14 and the current from switching regulator 16 cooperate to provide a summed output current. As the summed output current increases, the slope of the voltage droop of output voltage V_{OUT} decreases.

At time t₂, regulators 14 and 16 provide a summed current greater than load current I_{LOAD}, thus recharging output capacitor 76 and beginning to return output voltage V_{OUT} to regulation.

At time t₃, output voltage V_{OUT} exceeds the ASSIST threshold voltage, turning off assist signal ASSIST, which results in linear regulator 14 turning off. This leaves switching regulator 16 as the provider of current to the load. Because linear regulator 14 is off, it does not supply or provide any current to the load. As discussed hereinbefore, any leakage current from a regulator is sufficiently low that it is considered to be zero current.

At time t₄, voltage regulator 10 has returned to equilibrium, i.e., switching regulator 16 is providing a load current of sufficient magnitude that the output voltage V_{OUT} at output node 28 has stabilized, and output voltage V_{OUT} is regulated at its nominal voltage so that the change in output voltage ΔV_{OUT} substantially equals zero.

When the automobile returns to the key-off operating mode, load current I_{LOAD} decreases to a low level, e.g., less than approximately 2 mA, which is detected by comparator 104 causing linear regulator 14 to turn on and switching regulator 16 to turn off. Linear regulator 14 then provides load current I_{LOAD}.

By now it should be appreciated that a hybrid regulator circuit and method for improving load transient response in a regulated output voltage have been provided. In accordance with an embodiment of the present invention, the linear regulator circuit temporarily remains active or enabled while the switching regulator circuit is ramping up. This allows the linear regulator circuit to provide a sufficient amount of current to prevent the regulated output voltage from drooping or sagging to a level that may cause other circuitry to erroneously change state. An advantage of the present invention is that the linear and switching voltage regulators are switched on and off automatically in accordance with the load current levels, thereby increasing the speed of regulation.

It should be understood that voltage regulator 10 is not limited to automotive applications but may be used in other power applications.

Although certain preferred embodiments and methods have been disclosed herein, it will be apparent from the foregoing disclosure to those skilled in the art that variations and modifications of such embodiments and methods may be made without departing from the spirit and scope of the invention. For example, an output current sense resistor may be coupled between switching circuit 61 and V_{CC} or between inductor 74 and output node 28 to implement the switching regulator current sense function. Although regulator 14 is described as a linear regulator and regulator 16 is described as a switching regulator, regulators 14 and 16 can both be linear regulators or they can both be switching regulators. Further, it should be noted that the word “when” is taken to mean at the time an event occurs and while the event is occurring unless stated otherwise. It is intended that the invention shall be limited only to the extent required by the appended claims and the rules and principles of applicable law.

What is claimed is:

1. A method for regulating a voltage, comprising:
activating a first regulator, wherein the first regulator provides an output current;
activating a second regulator and deactivating the first regulator when the output current increases to a first predetermined level; and
reactivating the first regulator and deactivating the second regulator when the output current decreases to a second predetermined level.

2. The method of claim 1, wherein the first regulator is a linear regulator and the second regulator is a switching regulator.

3. The method of claim 1, wherein the first and second regulators are linear regulators.

4. The method of claim 1, wherein the first and second regulators are switching regulators.

5. The method of claim 1, wherein the first regulator initially remains activated after activating the second regulator.

6. A method for improving load transient response in a regulated output voltage, comprising:
enabling a first regulator to provide a first current level;
enabling a second regulator in response to a load current increasing to a second current level, wherein the first and second regulators cooperate to provide a summed output current; and
disabling the first regulator when the output voltage has stabilized to within a tolerance of a predetermined output voltage level, and wherein the second regulator provides the load current.

7. The method of claim 6, wherein the tolerance of the predetermined output voltage level is a voltage that ranges from approximately 1% to approximately 5% of the predetermined output voltage level.

8. The method of claim 6, wherein enabling the second regulator in response to the load current increasing to the second current level includes providing a control signal to the first regulator that maintains the first regulator in an enabled operating mode.

9. The method of claim 6, wherein the first regulator is a linear regulator and the second regulator is a switching regulator.

10. The method of claim 6, wherein the first and second regulators are linear regulators.

11. The method of claim 6, wherein the first and second regulators are switching regulators.

12. The method of claim 6, wherein the second regulator is a linear regulator.

13. A circuit having a circuit output, comprising:
a selector circuit having first and second current sensing inputs and a voltage sensing input;
a first regulator having a regulation output and a current sensing output, the current sensing output coupled to the first current sensing input of the selector circuit; and
a second regulator having a regulation output and a current sensing output, the current sensing output coupled to the second current sensing input of the selector circuit, and wherein the regulation outputs of the first and second regulators are coupled together.

14. The circuit of claim 13, further including a capacitor having a first terminal coupled to the outputs of the first and second regulators and a second terminal coupled for receiving a source of operating potential.

15. The circuit of claim 13, wherein the first regulator is a linear regulator and the second regulator is a switching regulator.

16. The circuit of claim 13, wherein the first and second regulators are switching regulators.

17. The circuit of claim 13, wherein the first and second regulators are linear regulators.

18. The circuit of claim 13, wherein the first regulator further includes an input and the selector circuit further includes an output, the output of the selector circuit coupled to the input of the first regulator.

19. The circuit of claim 13, wherein the second regulator includes an input and the selector circuit further includes an output, the output of the selector circuit coupled to the input of the second regulator.
